(19) United States
(12) Patent Application Publication
(10) Pub. No.: US 2009/0153745 A1
(43) Pub. Date: Jun. 18, 2009

(54) MULTI-VIEW CAMERA COLOR CALIBRATION METHOD USING COLOR CHECKER CHART

(75) Inventors: Ji Young Park, Daejeon (KR); Chang Woo Chu, Daejeon (KR); Ho Won Kim, Daejeon (KR); Seong Jae Lim, Daejeon (KR); Jeung Chul Park, Daejeon (KR); Bon Ki Koo, Daejeon (KR)

Correspondence Address: STAAS & HALSEY LLP, SUITE 700, 1201 NEW YORK AVENUE, N.W., WASHINGTON, DC, 20005, US

(73) Assignee: ELECTRONICS AND TELECOMMUNICATIONS RESEARCH INSTITUTE, Daejeon (KR)

(21) Appl. No.: 12/334,095

(22) Filed: Dec. 12, 2008

(30) Foreign Application Priority Data
Dec. 15, 2007 (KR) 10-2007-0131827

(51) Int. Cl. H04N 9/68

(52) U.S. Cl. 348/708; 348/E09.053

(57) ABSTRACT

A multi-view camera color calibration method using a color checker chart, includes measuring a brightness range of photographic data being input from multiple cameras; photographing the color checker chart for each camera and adjusting a brightness value of the chart to be within the brightness range of an input image of each camera; correcting brightness of each camera by using a gray patch of the checker chart; modeling a relationship between a color value of the checker chart obtained by each camera and a standard color value provided by the color checker chart; and correcting differences in color as a result of the modeling, to calibrate colors among the multiple cameras. Therefore, the three-dimensional information of a moving object for photography which cannot be photographed by moving only one camera is capable of being restored.

### CROSS-REFERENCE(S) TO RELATED APPLICATIONS

The present invention claims priority of Korean Patent Application No. 10-2007-0131827, filed on Dec. 15, 2007, which is incorporated herein by reference.

### FIELD OF THE INVENTION

The present invention relates to a multi-view camera color correction method, and more particularly, to a multi-view camera color calibration method using a color checker chart, which is used when combining images being photographed by multiple cameras in an image processing technique of performing three-dimensional information restoration and which is to correct differences in color which occur depending on the features of each camera or the photographing lighting conditions.

### BACKGROUND OF THE INVENTION

Typically, one of most general methods which are used for three-dimensional information restoration is to combine two-dimensional image information obtained from multiple views in diverse directions. For the combination of the information, it is important to find a corresponding point of the multiple views. However, even though the same model of cameras are used, since differences in the features of each sensor and the effects of lighting brightness depending on the position of each camera result in different color values of an obtained image, it is difficult to find the corresponding point. Accordingly, there is the need for a technique of correcting the differences in color caused by the peculiar features of each sensor and the lighting effect depending on the position of each camera when taking photographs.

Conventional methods for correcting differences in color occurring due to the features of each camera use the Macbeth color checker chart. However, since the conventional methods reflect only the hardware features of each camera, they cannot reflect any other conditions which may occur when actually taking photographs.

That is, when a photograph is simultaneously taken by multiple cameras from different views, color correction needs to be performed by reflecting the differences in not only the features of the multiple cameras but also the lighting effects depending on the positions of the cameras. However, since the conventional methods are performed in consideration with only the hardware features of the multiple cameras, instead of all of diverse peculiar information of the cameras, they have the problem in that differences in color are not accurately corrected.

### SUMMARY OF THE INVENTION

It is, therefore, an object of the present invention to provide a multi-view camera color calibration method, which is used when combining images being photographed by multiple cameras in an image processing technique of performing three-dimensional information restoration and which is to correct differences in color depending on the features of each cameras or the photographing lighting conditions by modeling a relationship to a standard color model in each camera.

In accordance with the present invention, there is provided a multi-view camera color calibration method using a color checker chart, including: measuring a brightness range of photographic data being input from multiple cameras; photographing the color checker chart for each camera and adjusting a brightness value of the chart to be within the brightness range of an input image of each camera; correcting brightness of each camera by using a gray patch of the checker chart; modeling a relationship between a color value of the checker chart obtained by each camera and a standard color value provided by the color checker chart; and correcting differences in color as a result of the modeling, to calibrate colors among the multiple cameras.

### BRIEF DESCRIPTION OF THE DRAWINGS

The above and other objects and features of the present invention will become apparent from the following description of embodiments given in conjunction with the accompanying drawings, in which:

FIG. 1 is a block diagram of the connection constitution between a computer and multiple cameras, for a multi-view camera color calibration function in accordance with an embodiment of the present invention;

FIG. 2 is a flow chart of a multi-view camera color calibration process in accordance with another embodiment of the present invention;

FIG. 3 shows an example of images having differences in color occurring from various views of multiple cameras in the conventional art;

FIG. 4 illustrates an example of images corrected to have the same color value by performing multi-view camera color calibration in accordance with an embodiment of the present invention; and

FIGS. 5a and 5b depict examples of color distribution corrected in accordance with an embodiment of the present invention.

### DETAILED DESCRIPTION OF THE EMBODIMENTS

Hereinafter, embodiments of the present invention will be described in detail with reference to the accompanying drawings so that they can be readily implemented by those skilled in the art.

Where the function and constitution are well-known in the relevant arts, further discussion will not be presented in the detailed description of the present invention in order not to unnecessarily make the gist of the present invention unclear. It will be understood that words or terms used in the specification and claims shall not be interpreted as the meaning defined in commonly used dictionaries. It will be further understood that the words or terms should be interpreted as having a meaning that is consistent with their meaning in the context of the relevant art and the technical idea of the invention, based on the intentions or practices of a user or an operator.

A specific technical gist of the present invention is to achieve the object of the present invention by the technique of correcting differences in color which occur depending on the features of each camera or the photographing lighting conditions by modeling a relationship to a standard color model in each camera, when combining images being photographed by multiple cameras in an image processing technique of performing three-dimensional information restoration.

A method for calibrating color values of images obtained by using multi-view cameras for three-dimensional restoration will be described with reference to drawings.

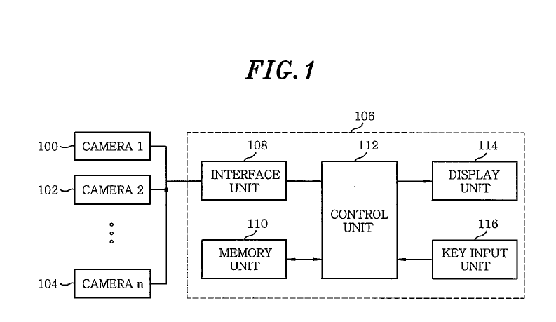

FIG. 1 illustrates the connection constitution between multiple cameras 100, 102 and 104 and a computer 106 loading an application program to perform a multi-view camera color calibration function in accordance with an embodiment of the present invention.

To restore three-dimensional information, the cameras 100, 102 and 104 take photographs of an object and transmit photographic data to the computer 106 connected to the cameras 100, 102 and 104. An interface 108 is connected to the cameras 100, 102 and 104 and applies an image data being photographed by the cameras 100, 102 and 104 to a control unit 112. A key input unit 116 comprises a number of numerical keys and functional keys. When a user inputs keys, the key input unit 116 generates corresponding key data to the control unit 112.

A memory unit 110 stores an operation control program to be run by the control unit 112 controlling overall operation. An application program to perform the multi-view camera color calibration in accordance with the present invention is loaded in the memory unit 110. When the color calibration function of the photographic data being input from the cameras 100, 102 and 104 is performed in line with the control of the control unit 112, a display unit 114 outputs a finally corrected color value as the result.

The control unit 112 controls the overall operation of the computer 106, based on the operation control program stored in the memory unit 110. When the color calibration operation of the photographic data obtained by the multiple cameras 100, 102 and 104 is performed in accordance with the embodiment of the present invention, the control unit 112 runs the application program loaded in the memory unit 110. As a result, when images being photographed by the multiple cameras 100, 102 and 104 are combined by the image processing technique of performing three-dimensional information restoration, the colors among the cameras 100, 102 and 104 are calibrated by correcting differences in color which are occurred depending on the features of the cameras 100, 102 and 104 or the photographing lighting conditions, by modeling a relationship to the standard color model in each camera.

That is, in order for the multiple cameras to display the same color characteristics, a standard color value is needed. The standard color uses the Macbeth color checker chart providing color values when photographing is performed on specific lighting conditions. Therefore, when the color checker chart is photographed to know the features of each camera used for photographing, the control unit 112 measures a brightness range indicated from input data to be corrected by each camera and adjusts a brightness value of the chart to be within the measured range when photographing the color checker chart for each corresponding camera. Thereafter, only a gray patch of the checker chart is used for fitting an input value for each RGB channel to a standard value model provided as a true value, thereby controlling the brightness of the multi-view cameras being used.

Then, in the images being photographed by the cameras, a value of each RGB representing each patch is taken within the region corresponding to 50% of the size of the patch and is set as an average value of pixels positioned in the center of the patch to minimize an influence of noise. Detailed correction of a color value is performed using the entire patches provided by the color checker chart. Accordingly, an equation representing the relationship between the color value of the patch obtained by each camera and the standard color value is set up and is applied to any input, thereby enabling to convert different inputs of the multi-view cameras into the same color.

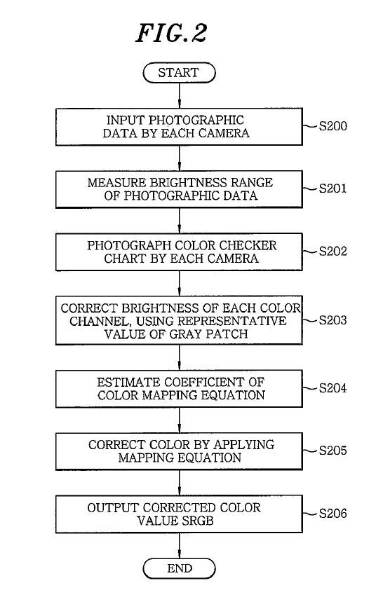

FIG. 2 illustrates a flow chart controlling the operation of calibrating color values of images being input from multiple cameras, in accordance with another embodiment of the present invention, which will be described in detail with reference to FIGS. 1 and 2.

When three-dimensional data restoration is performed, a control unit 112 runs the application program for calibrating colors of multiple cameras, which is loaded in a memory unit 110, to perform the operation of calibrating the colors among the multiple cameras, to restore the three-dimensional data.

In step 200, photographic data of a shot taken by multiple cameras 100, 102 and 104 in multiple directions for the purpose of the three-dimensional data restoration are input through an interface unit 108.

In step 201, since brightness of an image being input by each camera is influenced by differences in the features of each camera and in the effects of lighting depending on the position of each camera, a brightness range of the input image is measured from the photographic data.

In step 202, a color checker chart is photographed to establish a relationship to a standard color with respect to each camera. Then, a brightness value of the chart is adjusted to be within the range measured in step S201.

In step S203, the brightness of the multi-view cameras which are used for photographing is adjusted by fitting an input value of each RGB channel to a standard value model which is provided as a true value, using only a gray patch among a number of patches of the color checker chart. The value of each RGB representing each patch in the image being photographed by each camera is taken from the region corresponding to 50% of the size of the patch and is set as the average value of the pixels positioned in the center of the patch, to minimize the influence of noise.

In step S204, detailed correction of a color value is performed through the entire patches provided by the color checker chart. Then, an equation indicating the relationship between the color value of the patch obtained by each camera and the standard color value is found through the following processes:

A coefficient α of the relation equation is determined to satisfy a nonlinear equation like Formula 1, by using the patch color RGB values of the color checker being photographed by each camera:

$$X = {a}_{x 1} R + {a}_{x 2} G + {a}_{x 3} B + {a}_{x 4} RG + {a}_{x 5} RB + {a}_{x 6} GB + {a}_{x 7} {R}^{2} + {a}_{x 8} {G}^{2} + {a}_{x 9} {B}^{2} + {a}_{x 10} RGB + {a}_{x 11} {R}^{2} G + {a}_{x 12} {G}^{2} B + {a}_{x 13} {B}^{2} R + {a}_{x 14} {R}^{3} + {a}_{x 15} {G}^{3} + {a}_{x 16} {B}^{3} \\ Y = {a}_{y 1} R + {a}_{y 2} G + {a}_{y 3} B + {a}_{y 4} RG + {a}_{y 5} RB + {a}_{y 6} GB + {a}_{y 7} {R}^{2} + {a}_{y 8} {G}^{2} + {a}_{y 9} {B}^{2} + {a}_{y 10} RGB + {a}_{y 11} {R}^{2} G + {a}_{y 12} {G}^{2} B + {a}_{y 13} {B}^{2} R + {a}_{y 14} {R}^{3} + {a}_{y 15} {G}^{3} + {a}_{y 16} {B}^{3} \\ Z = {a}_{z 1} R + {a}_{z 2} G + {a}_{z 3} B + {a}_{z 4} RG + {a}_{z 5} RB + {a}_{z 6} GB + {a}_{z 7} {R}^{2} + {a}_{z 8} {G}^{2} + {a}_{z 9} {B}^{2} + {a}_{z 10} RGB + {a}_{z 11} {R}^{2} G + {a}_{z 12} {G}^{2} B + {a}_{z 13} {B}^{2} R + {a}_{z 14} {R}^{3} + {a}_{z 15} {G}^{3} + {a}_{z 16} {B}^{3} \qquad [ Formula 1 ]$$

Using the above Formula 1, a total of 48 coefficients, i.e., 16 coefficients for each of X, Y and Z, are estimated and can be expressed in determinant like Formula 2 below:

T=AD [Formula 2]

wherein coefficient matrix A is 3×16 matrix including αₓ₁ to α_{z16} and the size of matrix D is 16×n and is determined by the color values of the color patch being photographed by each camera.

Then, since an estimated coefficient is not completely inversely transformed, it is calculated through a pseudo inverse transform process like Formula 3 below:

A=D⁺T [Formula 3]

In step S205, multi-view camera color correction is performed by applying the above determined relation equation to the input image. As a result, in step S206, the colors of the multiple cameras are calibrated, outputting a corrected color value sRGB.

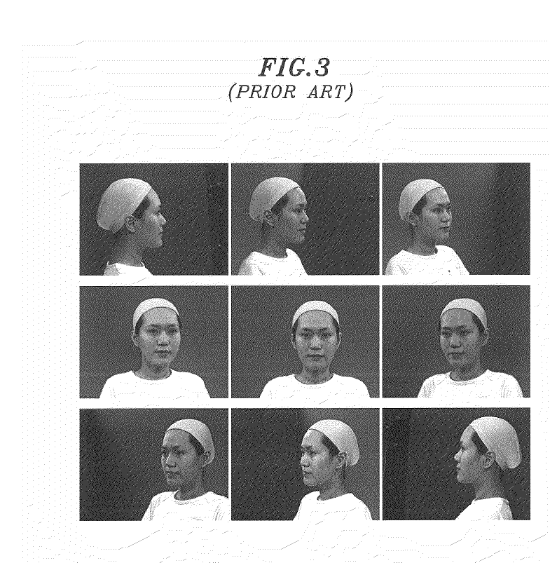

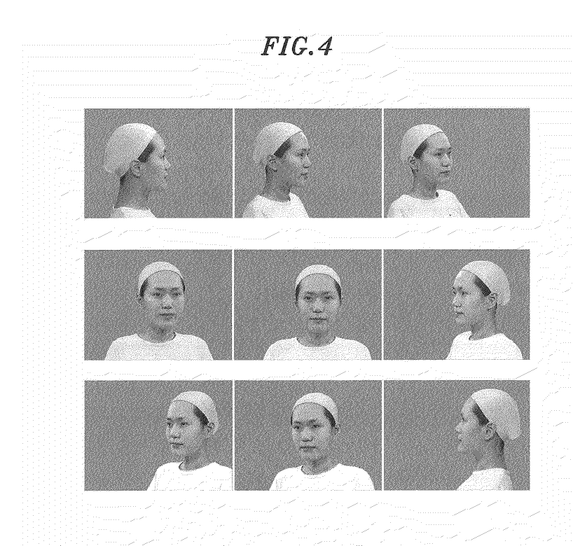

FIG. 3 shows input images being photographed by n-cameras (for example, n=9) illustrated in FIG. 2. FIG. 4 shows images resulting from color correction by performing the multi-view camera color calibration process of FIG. 2. As shown in FIG. 4, the colors of the images which are photographed in different directions and therefore have differences in color are calibrated through the color correction. Accordingly, color values, which are different depending on the multiple cameras, are corrected to the same value, enabling the information of the two-dimensional images to be effectively combined.

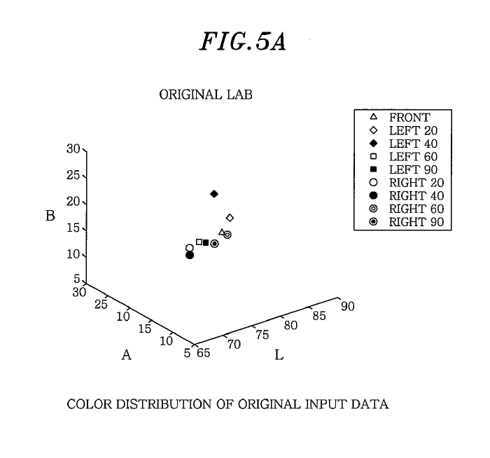

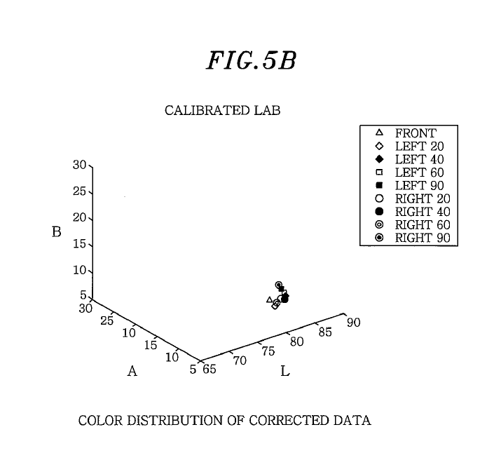

FIGS. 5a and 5b illustrate skin color distribution of the face of the model shown in FIGS. 3 and 4. The color distribution is illustrated in the CIELAB space, to compare quantitative color differences. That is, as shown in FIGS. 5a and 5b, the color distribution changes as the color calibration is performed.

In accordance with the present invention, when three-dimensional information is restored based on images obtained by using multiple cameras, different color values depending on the cameras are corrected to the same value, enabling the information of two-dimensional images to be effectively combined. Therefore, the present invention is useful to restore the three-dimensional information of a moving object for photography which cannot be photographed by moving only one camera.

While the invention has been shown and described with respect to the embodiments, it will be understood by those skilled in the art that various changes and modifications may be made without departing from the scope of the invention as defined in the following claims.

What is claimed is:

1. A multi-view camera color calibration method using a color checker chart, comprising:
calculating differences in color of images being simultaneously photographed by multiple cameras in multiple directions when restoring three-dimensional data; and
modeling a relationship between a color model for each camera and a standard color model of the color checker chart with respect to the differences in color and correcting the differences in color, to calibrate colors among the multi-cameras.

2. The multi-view camera color calibration method of claim 1, wherein, in the modeling a relationship, a coefficient of a color mapping equation between input image color information of the multiple cameras and standard color information of the color checker chart is estimated and the estimated coefficient is applied to calibrate input image color values of the multiple cameras.

3. The multi-view camera color calibration method of claim 1, wherein, in the modeling a relationship, the color model for each camera is obtained by calculating RGB values representing each patch in the image being photographed by each camera.

4. The multi-view camera color calibration method of claim 3, wherein the RGB values representing each patch in the image being photographed by each camera is taken in a region corresponding to 50% of the size of each patch and is calculated as an average value of pixels positioned in the center of each patch.

5. The multi-view camera color calibration method of claim 2, wherein the color checker chart is the Macbeth color checker chart.

6. A multi-view camera color calibration method using a color checker chart, comprising:
measuring a brightness range of photographic data being input from multiple cameras;
photographing the color checker chart for each camera and adjusting a brightness value of the chart to be within the brightness range of an input image of each camera;
correcting brightness of each camera by using a gray patch of the checker chart;
modeling a relationship between a color value of the checker chart obtained by each camera and a standard color value provided by the color checker chart; and
correcting differences in color as a result of the modeling, to calibrate colors among the multiple cameras.

7. The multi-view camera color calibration method of claim 6, wherein the modeling of a relationship is performed by estimating a coefficient of a color mapping equation between input image color information of the multiple cameras and standard color information of the color checker chart.

8. The multi-view camera color calibration method of claim 6, wherein, in the modeling a relationship, the color value for each camera is obtained by calculating RGB values representing each patch in the image being photographed by each camera.

9. The multi-view camera color calibration method of claim 8, wherein the ROB values representing each patch in the image being photographed by each camera is taken in a region corresponding to 50% of the size of each patch and is calculated as an average value of pixels positioned in the center of each patch.

10. The multi-view camera color calibration method of claim 7, wherein the color checker chart is the Macbeth color checker chart.
